(19) United States
(12) Patent Application Publication
(10) Pub. No.: US 2019/0311668 A1
(43) Pub. Date: Oct. 10, 2019

(54) INLINE PIXEL OPERATIONS BY THE DISPLAY PANEL CONTROLLER TO REDUCE HOST DATA TRANSFER

(71) Applicant: QUALCOMM Incorporated, San Diego, CA (US)

(72) Inventors: Dileep Marchya, Hyderabad (IN); Srinivas Pullakavi, Kakinada (IN)

(21) Appl. No.: 15/948,671

(22) Filed: Apr. 9, 2018

(51) Int. Cl. G09G 3/20

(52) U.S. Cl. CPC G09G 3/2003; G09G 3/2096; G09G 2320/0666; G09G 2360/18; G09G 2320/08; G09G 2370/022

(57) ABSTRACT

A display panel of a device may receive, from a host processor of the device, an inline pixel operation instruction comprising an indication of a first linear adjustment for a set of source pixel values for a display region of the display. The display panel may generate a pixel pattern for the display region by applying the first linear adjustment to the set of source pixel values and display the pixel pattern on the display. The display panel may in some cases read the set of source pixel values from a frame buffer of the device. The display panel may in some cases determine a color component tuple for each pixel of the display region based at least in part on the indication of the first linear adjustment, wherein the pixel pattern for the display region is based at least in part on the color component tuple.

### BACKGROUND

The following relates generally to refreshing a display at a display panel of a device, and more specifically to inline pixel operations by a display panel controller to reduce host data transfer.

The display of a device may be updated periodically (e.g., at a rate of sixty frames per second for some video applications) or aperiodically (e.g., in response to some user input). Updating the display may involve transferring pixel values from a host processor of the device to a display panel of the device. For example, the host processor may perform various processing operations (e.g., layer composition) to determine the pixel values, which processing operations may consume power. The transfer of pixel values from the host processor to the display panel may consume bitwidth of a system bus of the device or otherwise negatively impact the device (e.g., by consuming power). In some cases, the transferred pixel values within a given frame (e.g., or across multiple frames) may contain some level of redundancy. By way of example, multiple pixels within a single frame may be defined by the same color component values. Similarly, some pixels may vary only slightly (e.g., or not at all) between successive frames. Improved techniques for refreshing a display in consideration of such redundancies may be desired.

### SUMMARY

The described techniques relate to improved methods, systems, devices, or apparatuses that support inline pixel operations for displays. Generally, the described techniques provide for inline pixel operations, which may be performed by a display panel of a device (e.g., in order to reduce data transfer amounts from a host processor of the device). In accordance with the described techniques, the host processor may transfer only a portion of the pixel values used to refresh the display for a given frame (e.g., rather than transferring the entire pixel array for the frame to the display panel for display). A pixel pattern for the pixels not explicitly defined (e.g., pixels which do not have a specific set of color values configured by the host processor for display) may be determined using an inline pixel operation at the display panel. In some cases, the inline pixel operation may be based on an instruction from the host processor to the display panel (e.g., where the instruction is communicated instead of the explicit pixel values). Such techniques may decrease the amount of data being sent from the host processor to the display panel or provide other such benefits to the device.

A method of refreshing a display at a display panel of a device is described. The method may include receiving, from a host processor of the device, an inline pixel operation instruction for a display region of the display, wherein the inline pixel operation instruction comprises an indication of a first linear adjustment for a set of source pixel values, generating a pixel pattern for the display region by applying the first linear adjustment to the set of source pixel values, and displaying the pixel pattern on the display.

An apparatus for refreshing a display at a display panel of a device is described. The apparatus may include means for receiving, from a host processor of the device, an inline pixel operation instruction for a display region of the display, wherein the inline pixel operation instruction comprises an indication of a first linear adjustment for a set of source pixel values, means for generating a pixel pattern for the display region by applying the first linear adjustment to the set of source pixel values, and means for displaying the pixel pattern on the display.

Another apparatus for refreshing a display at a display panel of a device is described. The apparatus may include a processor, memory in electronic communication with the processor, and instructions stored in the memory. The instructions may be operable to cause the processor to receive, from a host processor of the device, an inline pixel operation instruction for a display region of the display, wherein the inline pixel operation instruction comprises an indication of a first linear adjustment for a set of source pixel values, generate a pixel pattern for the display region by applying the first linear adjustment to the set of source pixel values, and display the pixel pattern on the display.

A non-transitory computer-readable medium for refreshing a display at a display panel of a device is described. The non-transitory computer-readable medium may include instructions operable to cause a processor to receive, from a host processor of the device, an inline pixel operation instruction for a display region of the display, wherein the inline pixel operation instruction comprises an indication of a first linear adjustment for a set of source pixel values, generate a pixel pattern for the display region by applying the first linear adjustment to the set of source pixel values, and display the pixel pattern on the display.

Some examples of the method, apparatus, and non-transitory computer-readable medium described above may further include processes, features, means, or instructions for reading the set of source pixel values for the display region from a frame buffer of the display panel.

In some examples of the method, apparatus, and non-transitory computer-readable medium described above, applying the first linear adjustment to the set of source pixel values comprises applying a pixel multiplication factor to each pixel value of the set of source pixel values, wherein the indication of the first linear adjustment comprises the pixel multiplication factor.

Some examples of the method, apparatus, and non-transitory computer-readable medium described above may further include processes, features, means, or instructions for receiving, from the host processor of the device, a second inline pixel operation instruction for the display region of the display, wherein the second inline pixel operation instruction comprises an indication of a second linear adjustment. Some examples of the method, apparatus, and non-transitory computer-readable medium described above may further include processes, features, means, or instructions for reading the set of source pixel values for the display region from the frame buffer of the display panel. Some examples of the method, apparatus, and non-transitory computer-readable medium described above may further include processes, features, means, or instructions for generating, based at least in part on the second inline pixel operation instruction, a second pixel pattern for the display region by applying the second linear adjustment to the set of source pixel values. Some examples of the method, apparatus, and non-transitory computer-readable medium described above may further include processes, features, means, or instructions for displaying the second pixel pattern on the display.

In some examples of the method, apparatus, and non-transitory computer-readable medium described above, the first linear adjustment and the second linear adjustment comprise a same linear adjustment to the set of source pixel values such that the pixel pattern and the second pixel pattern comprise a same constant color block of pixels.

In some examples of the method, apparatus, and non-transitory computer-readable medium described above, the frame buffer of the display panel may be unchanged between the first linear adjustment to the set of source pixel values and a subsequent linear adjustment to the set of source pixel values.

In some examples of the method, apparatus, and non-transitory computer-readable medium described above, generating the pixel pattern for the display region comprises determining a color component tuple for each pixel of the display region based at least in part on the indication of the first linear adjustment, wherein the pixel pattern for the display region may be based at least in part on the color component tuple.

In some examples of the method, apparatus, and non-transitory computer-readable medium described above, applying the first linear adjustment to the set of source pixel values comprises applying a pixel multiplication factor to the color component tuple for each pixel of the display region, wherein the indication of the first linear adjustment comprises the pixel multiplication factor.

In some examples of the method, apparatus, and non-transitory computer-readable medium described above, applying the first linear adjustment to the set of source pixel values comprises creating an empty set of pixel values comprising the set of source pixel values. Some examples of the method, apparatus, and non-transitory computer-readable medium described above may further include processes, features, means, or instructions for adjusting each pixel value of the empty set of pixel values based on the color component tuple.

Some examples of the method, apparatus, and non-transitory computer-readable medium described above may further include processes, features, means, or instructions for receiving other pixel values for pixels outside the display region from the host processor of the device. Some examples of the method, apparatus, and non-transitory computer-readable medium described above may further include processes, features, means, or instructions for displaying the other pixel values on the display.

In some examples of the method, apparatus, and non-transitory computer-readable medium described above, applying the first linear adjustment to the set of source pixel values comprises passing the set of source pixel values to an array of arithmetic logic units (ALUs). Some examples of the method, apparatus, and non-transitory computer-readable medium described above may further include processes, features, means, or instructions for performing, by the array of ALUs and based at least in part on the inline pixel operation instruction, the first linear adjustment on the set of source pixel values.

### BRIEF DESCRIPTION OF THE DRAWINGS

FIG. 1 illustrates an example of a system for refreshing a display at a display panel of a device that supports inline pixel operations by a display panel controller to reduce host data transfer in accordance with aspects of the present disclosure.

FIG. 2 illustrates an example of a display operation that supports inline pixel operations by a display panel controller to reduce host data transfer in accordance with aspects of the present disclosure.

FIG. 3 illustrates an example of a display operation that supports inline pixel operations by a display panel controller to reduce host data transfer in accordance with aspects of the present disclosure.

FIG. 4 shows a block diagram of a device that supports inline pixel operations by a display panel controller to reduce host data transfer in accordance with aspects of the present disclosure.

FIG. 5 illustrates a block diagram of a system including a device that supports inline pixel operations by a display panel controller to reduce host data transfer in accordance with aspects of the present disclosure.

FIGS. 6 through 9 illustrate methods for inline pixel operations by a display panel controller to reduce host data transfer in accordance with aspects of the present disclosure.

### DETAILED DESCRIPTION

The proposed techniques relate to refreshing a display of a device (e.g., a camera, a wireless device such as a smartphone, tablet, wearable, or the like). The display may contain an array of pixels that is refreshed as the content to be displayed changes over time. The refresh operation may include a host processor transferring a refreshed array of pixels to a display panel, which may subsequently display the refreshed array of pixels. In some cases, redundant pixel information may exist within a single frame or across multiple frames. By way of example, a single frame may contain a constant color block, in which a block of pixels may be defined by a single color tuple. Similarly, temporally adjacent frames may vary slightly (e.g., some regions may not vary between frames).

As an example, a frame refresh operation (e.g., for a command mode of a device) may include a dimming operation. The dimming operation may include a black color block that is blended on top of the existing array of pixels (e.g., where the array of pixels may be stored in a frame buffer or a similar memory component). In this example, a linear transformation may occur such that the red-green-blue (RGB) pixel values for each pixel in the array remains unchanged (e.g., or unchanged relative to each other), but the “strength,” or alpha value, of the dimming operation increases. In some examples, the host processor may send the entire array of pixels to the display panel for each frame refresh during the dimming process. Other instances of refreshing the array of pixels may additionally suffer from such inefficiencies.

In accordance with the described techniques, inline pixel operations may be used by the display panel (e.g., in order to reduce data transfer amounts from a host processor). Rather than transferring the entire pattern of pixels to the display panel for display, a host processor may transfer only a portion of the pixels for a display refresh. The remaining portion may be determined using an inline pixel operation at the display panel. This flow of operations may decrease the amount of data being sent from the host processor to the display panel. In one example, the inline pixel operation may indicate a portion of pixels that have a uniform RGB value throughout. Additionally or alternatively, the inline pixel operation may include a modification (e.g., a uniform operation) for a given region of the pixel array for the previous frame (e.g., which pixel array may be stored in a frame buffer of the device). In each example, the display panel may determine a pixel pattern for displaying at least a portion of the total pixel array (e.g., rather than receiving the entire pixel array from the host processor). The described techniques may allow for inline pixel operations to be used (e.g., in order to reduce data transfers from a host processor to a display panel or provide other such benefits).

Aspects of the disclosure are initially described in the context of a system for refreshing a display at a display panel of a device. Aspects of the disclosure are then described in the context of display operations. Aspects of the disclosure are further illustrated by and described with reference to apparatus diagrams, system diagrams, and flowcharts that relate to inline pixel operations for displays.

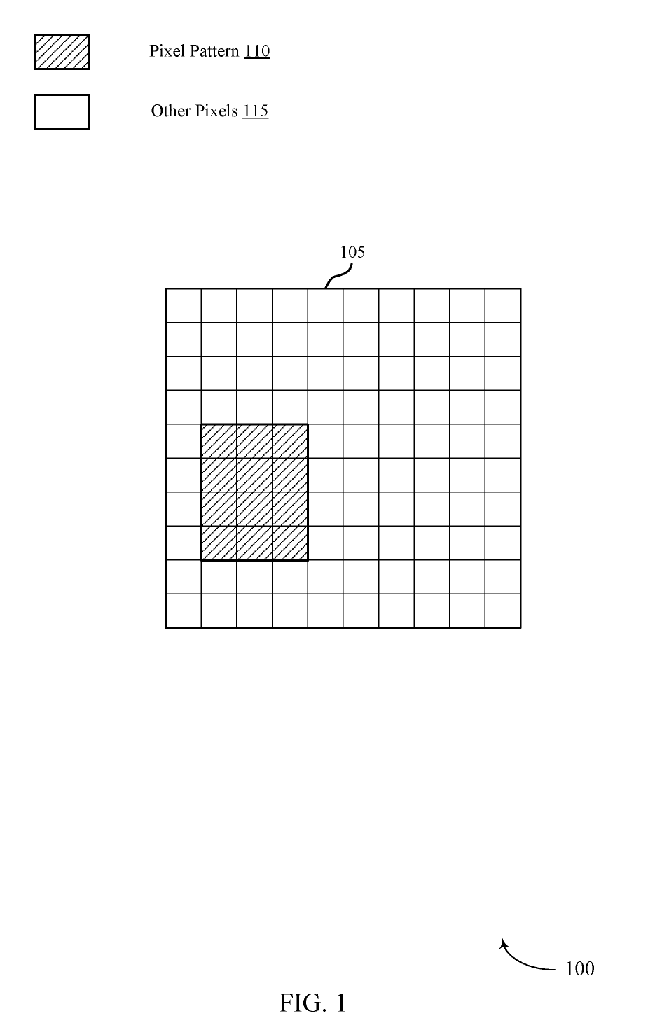

FIG. 1 illustrates an example of a pixel array 100. In some cases, pixel array 100 may be used for display on a device. Pixel array 100 may be generated in a variety of ways in accordance with the present disclosure. In some cases, pixel array 100 may be generated by a graphics processing unit (GPU) of a device. For example, the GPU may generate (e.g., or be involved in generating) a pixel array 100 for each frame in a sequence of frames (e.g., by performing one or more rendering operations to generate set of layers). A host processor of the device (e.g., which may refer to the GPU or some other processor of the device) may then transfer the pixel array 100 to a display panel of the device. For example, the GPU may perform various rendering operations to generate pixel array 100 (e.g., or portions thereof), while the host processor may perform composition of various layers rendered by the GPU (e.g., which composition may alternatively be referred to as blending in some cases).

A display panel may generally refer to a screen (e.g., a display) as well as one or more components modulating the content that appears on the screen. Examples of such components include liquid crystals, plasma, light-emitting diodes, and the like. In some cases, a display panel may additionally be associated with hardware supporting the content modulation. Examples are provided below in the context of a frame buffer and display panel controller, each of which may serve to complement the operations of the GPU and/or host processor. For example, the display panel controller may in some cases perform one or more inline pixel operations, as discussed further below.

In some cases pixel array 100 may change (e.g., significantly) from one frame to the next. For example, if a device is displaying a video stream, the pixel array 100 may vary between frames (e.g., may form completely different images from one frame to another). However, in some cases, pixel array 100 may be less volatile from one frame to another. In some such examples, a pixel pattern 110 may be generated using inline pixel operations in accordance with the present disclosure. Inline pixel operations may refer to a pixel operation that may be programmed by a host processor and may reduce power consumption for the device. Although pixel array 100 contains one such pixel pattern 110 which is determined using inline pixel operations, it is to be understood that pixel array 100 may contain any suitable number of regions which may be determined using inline pixel operations. In some cases, each such region may be determined using a respective inline pixel operation. Alternatively, two or more of the regions may be determined using a same inline pixel operation. Additionally, while pixel pattern 110 is illustrated as a rectangle, it is to be understood that in some cases the shape of pixel pattern 110 may be another regular shape (e.g., an octagon) or irregular shape (e.g., based on some heuristics associated with the display) without deviating from the scope of the present disclosure.

The inline pixel operations used to generate pixel pattern 110 may include a common operation to be done on all of the pixels 105 within pixel pattern 110. In some cases, the operation may include a manipulation of the pixels 105 corresponding to pixel pattern 110 (e.g., from the preceding frame). For example, in the case of a dimming operation, each pixel 105 in pixel pattern 110 may be uniformly adjusted (e.g., such that each pixel 105 from pixel pattern 110 dims at a constant rate). Additionally or alternatively, the inline processing operation may include assigning a single RGB value to each pixel 105 within pixel pattern 110. For example, instead of updating each pixel 105 of pixel array 100, a region of pixel array 100 corresponding to pixel pattern 110 may be defined with reference to a constant color block (e.g., such that pixel pattern 110 may be defined by a single RGB value).

Constant color blocks and dimming animations may be components of various user interface (UI) applications and themes (e.g., text applications, image applications, pop-ups, application launches, status bars, etc.). In each case, a GPU may render constant color blocks into a system memory (e.g., a frame buffer or some other memory component of the device). A display processor (e.g., which may alternatively be referred to as a host processor in aspects of the following) may fetch these constant color blocks and transfer the pixel values to a display panel (e.g., via a display serial interface (DSI) link, which may alternatively be referred to as a system bus). Such a transfer of pixel values (e.g., for pixel pattern 110) may be extraneous for cases in which the same RGB pixel value is present for the entire region of the constant color block.

The inline pixel operations described herein may decrease the amount of data transferred between the host processor and the display panel (e.g., such that only pixel values for other pixels 115 are transferred from the host processor to the display panel). In some cases, these techniques may decrease power consumption during a frame refresh operation. For example, a dimming operation may consume less power if the operation is performed using inline pixel operations rather than through transferring a full array of pixels from the host processor to the display panel for every frame (e.g., or for every group of frames). Inline pixel operations may also decrease bus traffic in some examples.

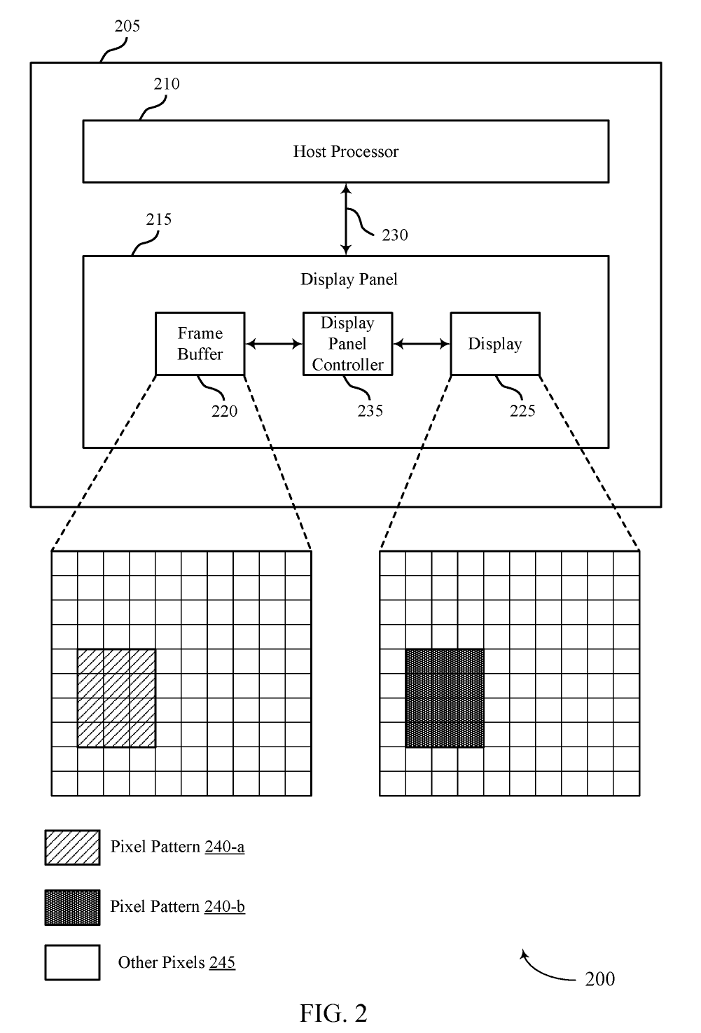

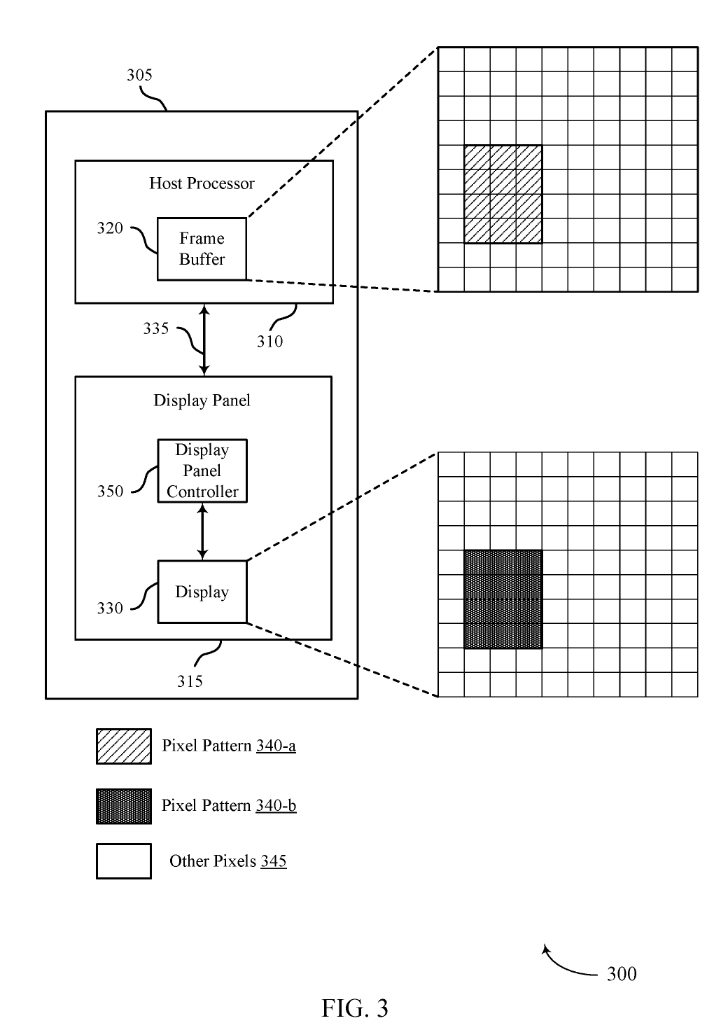

Aspects of the following relate to enhancements for display panel hardware (e.g., to support inline arithmetic operations driven by software executed on a host processor). In accordance with the described techniques, a display panel may support regions (e.g., corresponding to pixel pattern 110) where a pixel operation may be programmed by a host processor. The display controller (e.g., which may be a component of the display panel) may perform the specified operation on the pixels fetched from the memory (e.g., a frame buffer, which may be a component of the display panel as described with reference to FIG. 2 or may be distinct from the display panel as described with reference to FIG. 3) while refreshing the display.

Various benefits may be provided to a device operating in accordance with the described techniques. For example, aspects of the following may reduce data fetching operations, display/GPU composition clocks, and data transfer over a physical link of the device. In some cases, the power savings may be proportional to the number of pixels included in pixel pattern 110. In some examples (e.g., for color-fill operations), constant color block generation by the display panel may also benefit a GPU of the device (e.g., by allowing the GPU to skip pixels while rendering). In some cases, graphics software may be enhanced to detect the display panel capabilities of a device. Based on the detected capabilities, the graphics software may skip uniform color block processing by a GPU (e.g., at a finer level) and transfer commands to the display panel instead, as described further below.

FIG. 2 illustrates an example of a display operation 200 that supports inline pixel operations in accordance with various aspects of the present disclosure. Display operation 200 is described in the context of a device 205. In some examples, display operation 200 may represent operations for a command mode of device 205. Device 205 may be an example of a wireless-capable device, a camera, a monitor, or any other device containing a display.

Host processor 210 may communicate with display panel 215 over DSI link 230. In accordance with aspects of the present disclosure, host processor 210 may transfer one or more inline pixel operation commands to display panel 215 over DSI link 230 (e.g., during frame updates). In some cases, display panel 215 may include a frame buffer 220 (e.g., for storing pixel arrays or other frame-related information). Display panel 215 may update display 225 based at least in part on the information stored in frame buffer 220, which information may be communicated between frame buffer 220 and display 225 via link 235. In some cases, the information stored in frame buffer 220 may be modified (e.g., or supplemented) based on the one or more inline pixel operations (e.g., which may be performed by display panel controller 235).

For example, host processor 210 may transfer pixel values for other pixels 245 via DSI link 230 and indicate an inline pixel operation for a pixel pattern 240-b (e.g., where the other pixels 245 and the pixel pattern 240-b may comprise a frame to be displayed via display 225). The inline pixel operation may allow display panel controller 235 to update only a portion of the information stored in frame buffer 220 (e.g., while simply modifying the pixels corresponding to pixel pattern 240-b using the inline pixel operation). Alternatively, the inline pixel operation may obviate or reduce the need to update frame buffer 220 for a set of frames. That is, the display panel controller 235 may in some cases not rewrite the information in frame buffer 220 (e.g., such that frame buffer 220 remains the same across multiple frames). Host processor 210 may send a command via DSI link 230 containing the information necessary for display panel controller 235 to execute an inline pixel operation. The command for the inline pixel operation may include the specified region for the inline pixel operation (e.g., a frame buffer rectangle, a line of pixels, a specific group of pixels, or the like which may be represented in display operation 200 by pixel pattern 240-a), a pixel multiplication factor (PMF), a constant RGB tuple (kRGB), or the like. The inline pixel operation(s) may include a common operation applied to each pixel in pixel pattern 240-a such that there may be a linear transformation of the pixel values from pixel pattern 240-a to the modified pixel values of pixel pattern 240-b.

Display panel controller 235 may update pixel values corresponding to pixel pattern 240-b according to the instructions transferred from host processor 210 over DSI link 230. In some cases, display panel controller 235 may leave pixel pattern 240-a unchanged in frame buffer 220. That is, the pixel array stored in frame buffer 220 may contain updated other pixels 245 (e.g., updated based on information received from host processor 210) and residual pixels for pixel pattern 240-a. Alternatively, the entire pixel array stored in frame buffer 220 may remain unchanged between successive display refresh operations.

In some cases, the inline pixel operation may be defined according to equation 1. Each pixel of pixel pattern 240-b (e.g., which may be referred to as display pixels) may be determined by multiplying each source pixel (e.g., corresponding to pixel pattern 240-a) from frame buffer 220 by a PMF and/or by adding a kRGB to each source pixel.

DisplayPixel=(PMF/255)*SourcePixel+kRGB (1)

In some cases, the inline pixel operation may be used to define a dimming operation. For example, a PMF value of 192 and a kRGB value of (0, 0, 0) may correspond to a 75% dimming operation. In other cases, the inline pixel operation may be used to define a portion of a constant color block. For example, a PMF of 0 and a kRGB value of (255, 165, 0) may correspond to an orange color block. In each of these cases, pixels of pixel pattern 240 may undergo a common transformation while the other pixels 245 may be refreshed by host processor 210.

In some cases, the inline pixel operation may be performed by an array of arithmetic logic units (ALUs), or other such hardware which may be operable to perform techniques analogous to those described with reference to equation 1. For example, the array of ALUs may receive the source pixel values (e.g., corresponding to pixel pattern 240-a) as one input and the linear adjustment parameters (e.g., the PMF and/or kRGB) as another set of inputs. The array of ALUs may generate pixel pattern 240-b by performing the linear adjustment. In some cases, the array of ALUs may be associated with display panel controller 235 (e.g., may be components of display panel controller 235 or otherwise responsive to commands received from display panel controller 235).

FIG. 3 illustrates an example of a display operation 300 that supports inline pixel operations for displays in accordance with various aspects of the present disclosure. Display operation 300 is described in the context of a device 305. In some examples, display operation 300 may represent operations for a video mode of device 305. Device 305 may be an example of a wireless-capable device, a camera, a monitor, or any other device containing a display. In some cases, device 305 may be an example of device 205 described with reference to FIG. 2. That is, device 305 may in some cases be operable to switch between a video mode and a command mode. Alternatively, device 205 and device 305 may represent distinct devices (e.g., with different hardware configurations). As an example of such a distinction, display panel 215 of device 205 may contain a memory component (e.g., frame buffer 220), while display panel 315 of device 305 may not contain such memory (e.g., or may have the memory disabled for certain operations).

In some cases, host processor 310 may communicate with display panel 315 over DSI link 335. Host processor 310 may transfer a pixel array for a frame over DSI link 335 during frame updates. The pixel array may pass through a display panel controller 350 (e.g., a display driver) before being displayed on display 330. However, in some cases, rather than transferring the entire pixel array over DSI link 335, host processor 310 may instead only transfer a first portion of the pixel array (e.g., corresponding to other pixels 345) over DSI link 335. Rather than transferring pixel values for the region corresponding to pixel pattern 340-a, host processor 310 may instead indicate an inline pixel operation for these pixels. Host processor 310 may send a command via DSI link 335 containing the information necessary for display panel controller 350 to perform the inline pixel operation.

The command for the inline pixel operation may include the specified region for the inline pixel operation (e.g., a frame buffer rectangle, a PMF, a kRGB tuple, a combination thereof). Display panel controller 350 may perform the inline pixel operation(s) on the specified region (e.g., pixel pattern 340-a) to generate pixel pattern 340-b for display. By way of example, display panel controller 350 may apply a linear adjustment to pixel values received from host processor 310 over DSI link 335 (e.g., or may apply the linear adjustment to an empty set of pixel values which is created for the specified region). Display 330 may display the refreshed other pixels 345 as well as the pixels generated by the inline processing operation indicated by host processor 310 for pixel pattern 340-b.

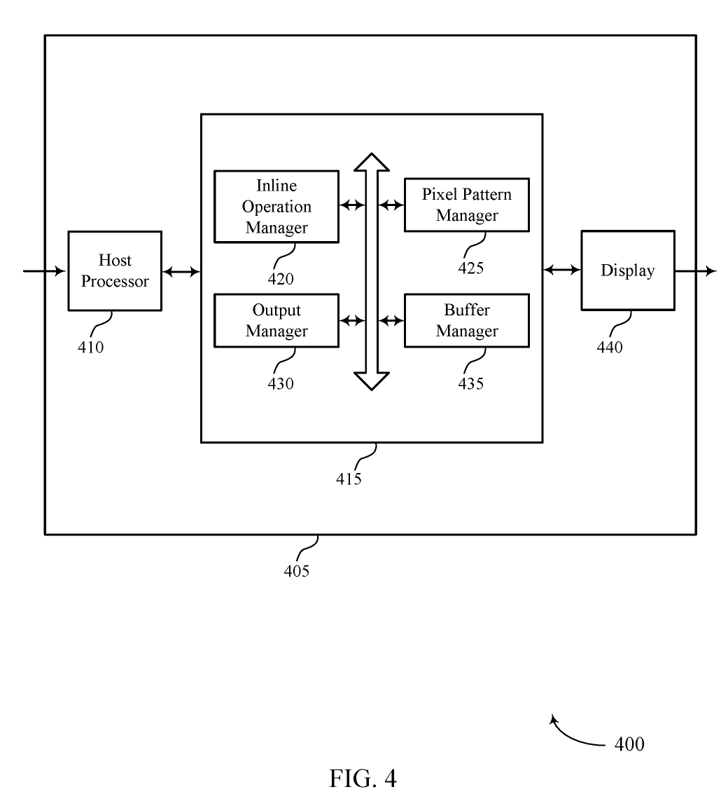

FIG. 4 shows a block diagram 400 of a device 405 that supports inline pixel operations for displays in accordance with aspects of the present disclosure. Device 405 may include host processor 410, display panel 415, and display 440. Each of these components may be in communication with one another (e.g., via one or more buses).

Host processor 410 may be or include a digital signal processor (DSP), general purpose microprocessor, application specific integrated circuit (ASIC), field programmable logic array (FPGA), or other equivalent integrated or discrete logic circuitry. Host processor 410 may execute one or more software applications. Examples of the applications may include operating systems, word processors, web browsers, e-mail applications, spreadsheets, video games, audio and/or video capture, playback or editing applications, or other such applications that initiate the generation of image data to be presented via display 440.

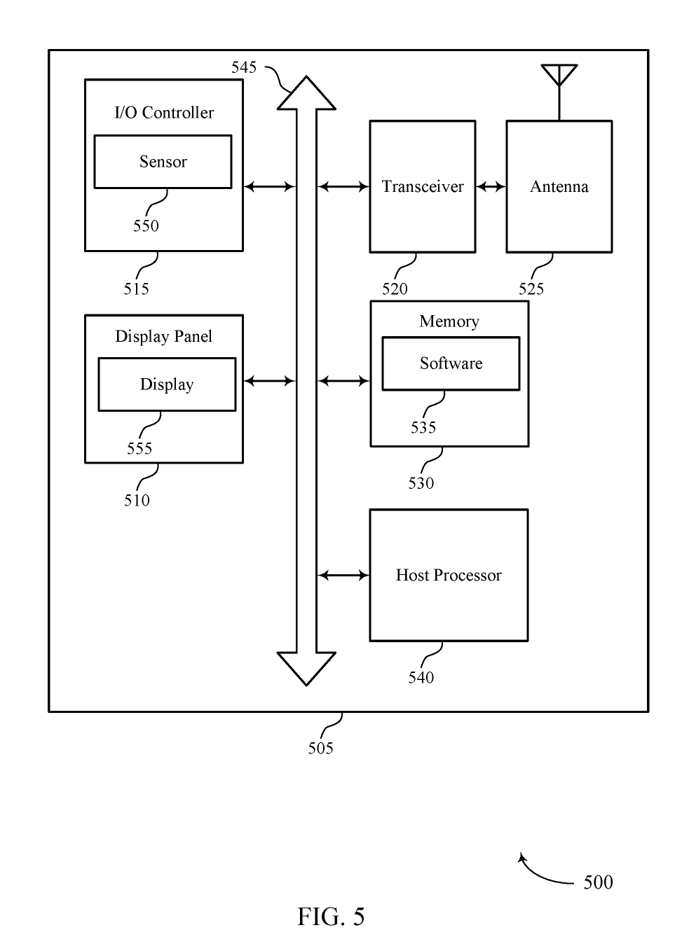

Display panel 415 may be an example of aspects of display panel 215 described with reference to FIG. 2, display panel 315 described with reference to FIG. 3, or display panel 510 described with reference to FIG. 5. Display panel 415 and/or at least some of its various sub-components may be implemented in hardware, software executed by a processor, firmware, or any combination thereof. If implemented in software executed by a processor, the functions of the display panel 415 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. In aspects of the following, the hardware used to perform aspects of the functions described herein may be generally referred to as an array of ALUs.

The display panel 415 and/or at least some of its various sub-components may be physically located at various positions, including being distributed such that portions of functions are implemented at different physical locations by one or more physical devices. In some examples, display panel 415 and/or at least some of its various sub-components may be a separate and distinct component in accordance with various aspects of the present disclosure. In other examples, display panel 415 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The display panel 415 may include inline operation manager 420, pixel pattern manager 425, output manager 430, and buffer manager 435. Each of these modules may communicate, directly or indirectly, with one another (e.g., via one or more buses).

Inline operation manager 420 may receive, from host processor 410, an inline pixel operation instruction for a display region of display 440, where the inline pixel operation instruction includes an indication of a first linear adjustment for a set of source pixel values. In some cases, inline operation manager 420 may receive, from host processor 410, a second inline pixel operation instruction for the display region of display 440, where the second inline pixel operation instruction includes an indication of a second linear adjustment.

Pixel pattern manager 425 may generate a pixel pattern for the display region by applying the first linear adjustment to the set of source pixel values. Similarly, pixel pattern manager 425 may generate, based on the second inline pixel operation instruction, a second pixel pattern for the display region by applying the second linear adjustment to the set of source pixel values. Pixel pattern manager 425 may adjust each pixel value of the empty set of pixel values based on the color component tuple. Pixel pattern manager 425 may pass the set of source pixel values to an array of ALUs and perform, via the array of ALUs and based on the inline pixel operation instruction, the first linear adjustment on the set of source pixel values.

In some cases, generating the pixel pattern for the display region includes determining a color component tuple for each pixel of the display region based on the indication of the first linear adjustment, where the pixel pattern for the display region is based on the color component tuple. In some cases, the first linear adjustment and the second linear adjustment include a same linear adjustment to the set of source pixel values such that the pixel pattern and the second pixel pattern include a same constant color block of pixels. In some cases, applying the first linear adjustment to the set of source pixel values includes applying a pixel multiplication factor to each pixel value of the set of source pixel values, where the indication of the first linear adjustment includes the pixel multiplication factor. In some cases, applying the first linear adjustment to the set of source pixel values includes applying a pixel multiplication factor to the color component tuple for each pixel of the display region, where the indication of the first linear adjustment includes the pixel multiplication factor. In some cases, applying the first linear adjustment to the set of source pixel values includes creating an empty set of pixel values including the set of source pixel values. By way of example, with reference to FIG. 2, pixel pattern manager 425 may instantiate an empty set of pixel values corresponding to pixel pattern 240-a (e.g., such that each pixel within pixel pattern 240-a has an empty set of RGB values) and apply the first linear adjustment (e.g., kRGB, PMF, etc.) to the empty set of pixel values to generate pixel pattern 240-b.

Output manager 430 may display the pixel pattern on the display 440. For example, output manager 430 may receive other pixel values for pixels outside the display region from host processor 410 and display the pixel pattern (or the second pixel pattern) and the other pixel values via display 440.

Buffer manager 435 may read the set of source pixel values for the display region from a frame buffer. In some cases, the frame buffer may be unchanged between the first linear adjustment to the set of source pixel values and a subsequent linear adjustment to the set of source pixel values.

Display 440 may represent a unit capable of displaying video, images, text or any other type of data for consumption by a viewer. Display 440 may include a liquid-crystal display (LCD), a light-emitting diode (LED) display, an organic LED (OLED), an active-matrix OLED (AMOLED), or the like. In some cases, display 440 may be a component of (e.g., or otherwise controlled by) display panel 415.

FIG. 5 shows a diagram of a system 500 including a device 505 that supports inline pixel operations for displays in accordance with aspects of the present disclosure. Device 505 may be an example of or include the components of device 405. Device 505 may include components for bi-directional voice and data communications including components for transmitting and receiving communications. Device 505 may include display panel 510 (e.g., which may include display 555), I/O controller 515, transceiver 520, antenna 525, memory 530, software 535, and host processor 540. These components may be in electronic communication via one or more buses (e.g., bus 545).

Host processor 540 may include an intelligent hardware device, (e.g., a general-purpose processor, a DSP, an ISP, a CPU, a GPU, a microcontroller, an ASIC, a FPGA, a programmable logic device, a discrete gate or transistor logic component, a discrete hardware component, or any combination thereof). In some cases, host processor 540 may be configured to operate a memory array using a memory controller. In other cases, a memory controller may be integrated into host processor 540. Host processor 540 may be configured to execute computer-readable instructions stored in a memory to perform various functions (e.g., functions or tasks supporting face tone color enhancement).

I/O controller 515 may manage input and output signals for device 505. I/O controller 515 may also manage peripherals not integrated into device 505. In some cases, I/O controller 515 may represent a physical connection or port to an external peripheral. In some cases, I/O controller 515 may utilize an operating system such as iOS®, ANDROID®, MS-DOS®, MS-WINDOWS®, OS/2®, UNIX®, LINUX®, or another known operating system. In other cases, I/O controller 515 may represent or interact with a modem, a keyboard, a mouse, a touchscreen, or a similar device. In some cases, I/O controller 515 may be implemented as part of a processor. In some cases, a user may interact with device 505 via an I/O controller 515 or via hardware components controlled by I/O controller 515. In some cases, I/O controller 515 may be or include sensor 550. Sensor 550 may be an example of a digital imaging sensor for taking photos and video.

Transceiver 520 may communicate bi-directionally, via one or more antennas, wired, or wireless links as described above. For example, the transceiver 520 may represent a wireless transceiver and may communicate bi-directionally with another wireless transceiver. The transceiver 520 may also include a modem to modulate the packets and provide the modulated packets to the antennas for transmission, and to demodulate packets received from the antennas. In some cases, the wireless device may include a single antenna 525. However, in some cases the device may have more than one antenna 525, which may be capable of concurrently transmitting or receiving multiple wireless transmissions.

Device 505 may participate in a wireless communications system (e.g., may be an example of a mobile device). A mobile device may also be referred to as a UE, a wireless device, a remote device, a handheld device, or a subscriber device, or some other suitable terminology, where the “device” may also be referred to as a unit, a station, a terminal, or a client. A mobile device may be a personal electronic device such as a cellular phone, a PDA, a tablet computer, a laptop computer, or a personal computer. In some examples, a mobile device may also refer to a WLL station, an IoT device, an IoE device, a MTC device, or the like, which may be implemented in various articles such as appliances, vehicles, meters, or the like.

Memory 530 may comprise one or more computer-readable storage media. Examples of memory 530 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. Memory 530 may store program modules and/or instructions that are accessible for execution by host processor 540. That is, memory 530 may store computer-readable, computer-executable software 535 including instructions that, when executed, cause the processor to perform various functions described herein. In some cases, the memory 530 may contain, among other things, a basic input/output system (BIOS) which may control basic hardware or software operation such as the interaction with peripheral components or devices. The software 535 may include code to implement aspects of the present disclosure, including code to support deep-learning-based color enhancement systems. Software 535 may be stored in a non-transitory computer-readable medium such as system memory or other memory. In some cases, the software 535 may not be directly executable by the processor but may cause a computer (e.g., when compiled and executed) to perform functions described herein.

Display panel 510 may represent a means for controlling display 555. Display panel 510 and/or at least some of its various sub-components may be implemented in hardware, software executed by a processor, firmware, or any combination thereof. If implemented in software executed by a processor, the functions of the display panel 510 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. In some cases, display panel 510 may share hardware (e.g., ALUs) with host processor 540.

Display 555 represents a unit capable of displaying video, images, text or any other type of data for consumption by a viewer. Display 555 may include a LCD, a LED display, an OLED, an AMOLED, or the like. In some cases, display 555 and I/O controller 515 may be or represent aspects of a same component (e.g., a touchscreen) of device 505.

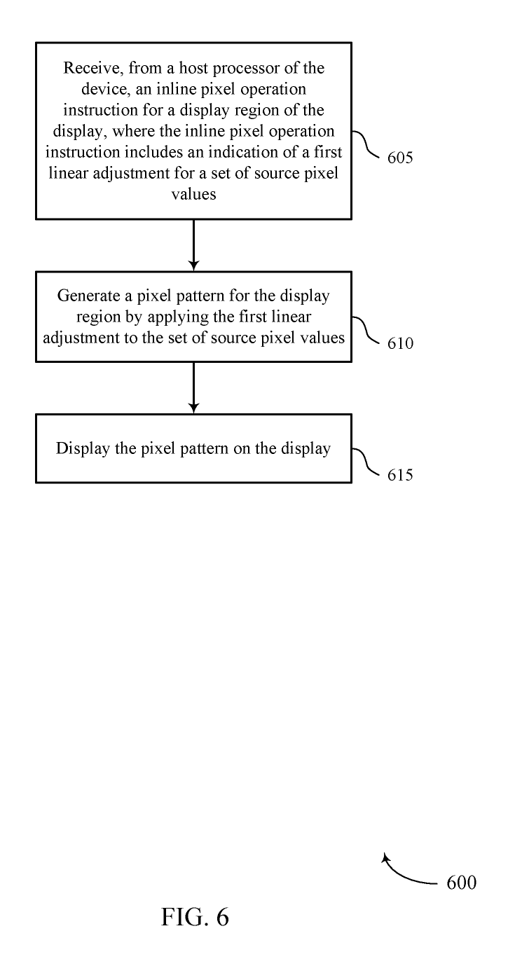

FIG. 6 shows a flowchart illustrating a method 600 for inline pixel operations for displays in accordance with aspects of the present disclosure. The operations of method 600 may be implemented by a device or its components as described herein. For example, the operations of method 600 may be performed by a display panel as described with reference to FIGS. 4 and 5. In some examples, a device may execute a set of codes to control the functional elements of the device to perform the functions described below. Additionally or alternatively, the device may perform aspects of the functions described below using special-purpose hardware.

At 605 the display panel may receive, from a host processor of the device, an inline pixel operation instruction for a display region of the display, wherein the inline pixel operation instruction comprises an indication of a first linear adjustment for a set of source pixel values. The operations of 605 may be performed according to the methods described herein. In certain examples, aspects of the operations of 605 may be performed by a inline operation manager as described with reference to FIGS. 4 and 5.

At 610 the display panel may generate a pixel pattern for the display region by applying the first linear adjustment to the set of source pixel values. The operations of 610 may be performed according to the methods described herein. In certain examples, aspects of the operations of 610 may be performed by a pixel pattern manager as described with reference to FIGS. 4 and 5.

At 615 the display panel may display the pixel pattern on the display. The operations of 615 may be performed according to the methods described herein. In certain examples, aspects of the operations of 615 may be performed by a output manager as described with reference to FIGS. 4 and 5.

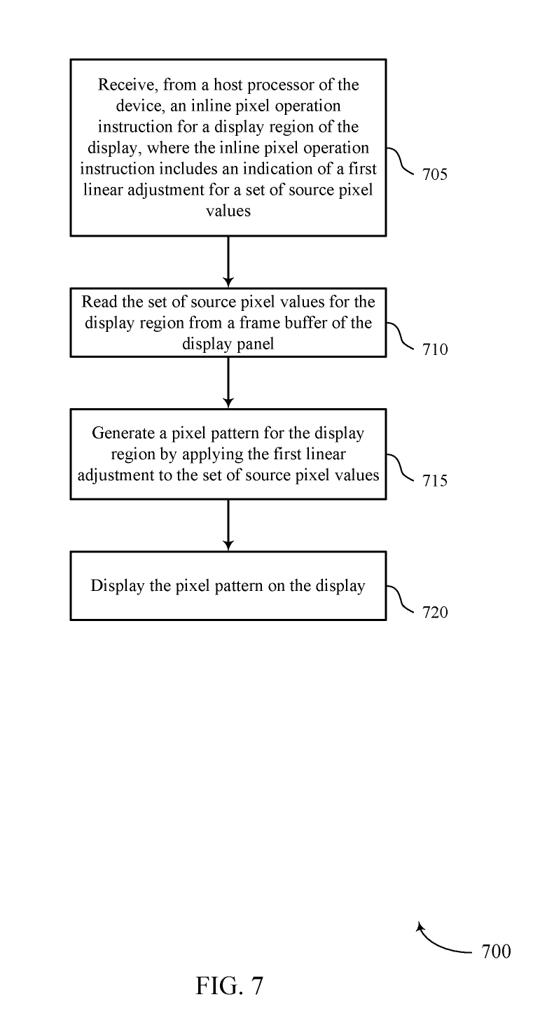

FIG. 7 shows a flowchart illustrating a method 700 for inline pixel operations for displays in accordance with aspects of the present disclosure. The operations of method 700 may be implemented by a device or its components as described herein. For example, the operations of method 700 may be performed by a display panel as described with reference to FIGS. 4 and 5. In some examples, a device may execute a set of codes to control the functional elements of the device to perform the functions described below. Additionally or alternatively, the device may perform aspects of the functions described below using special-purpose hardware.

At 705 the display panel may receive, from a host processor of the device, an inline pixel operation instruction for a display region of the display, wherein the inline pixel operation instruction comprises an indication of a first linear adjustment for a set of source pixel values. The operations of 705 may be performed according to the methods described herein. In certain examples, aspects of the operations of 705 may be performed by a inline operation manager as described with reference to FIGS. 4 and 5.

At 710 the display panel may read the set of source pixel values for the display region from a frame buffer of the display panel. The operations of 710 may be performed according to the methods described herein. In certain examples, aspects of the operations of 710 may be performed by a buffer manager as described with reference to FIGS. 4 and 5.

At 715 the display panel may generate a pixel pattern for the display region by applying the first linear adjustment to the set of source pixel values. The operations of 715 may be performed according to the methods described herein. In certain examples, aspects of the operations of 715 may be performed by a pixel pattern manager as described with reference to FIGS. 4 and 5.

At 720 the display panel may display the pixel pattern on the display. The operations of 720 may be performed according to the methods described herein. In certain examples, aspects of the operations of 720 may be performed by a output manager as described with reference to FIGS. 4 and 5.

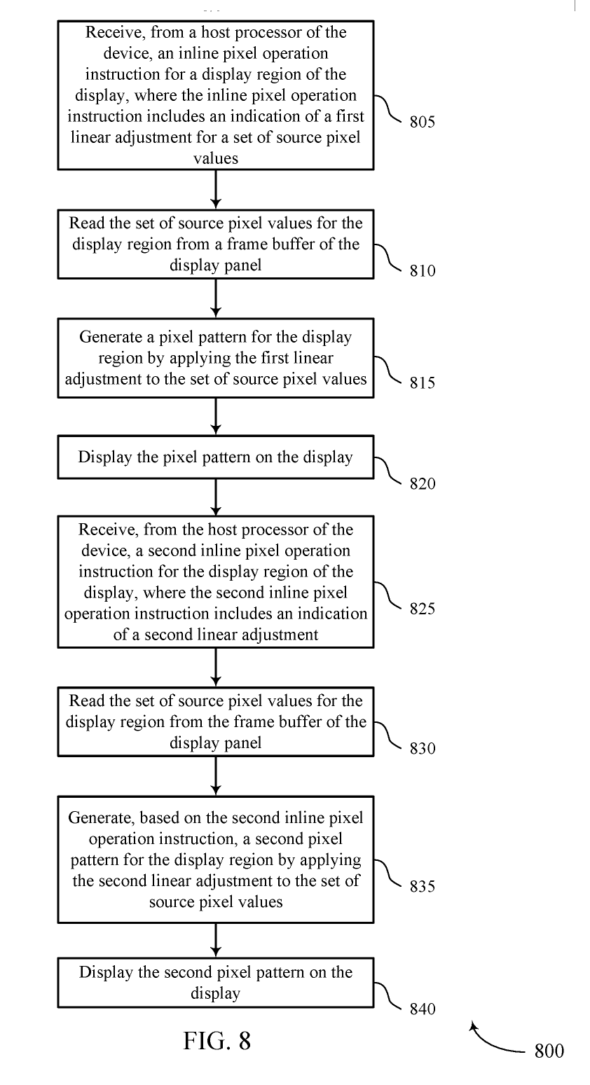

FIG. 8 shows a flowchart illustrating a method 800 for inline pixel operations for displays in accordance with aspects of the present disclosure. The operations of method 800 may be implemented by a device or its components as described herein. For example, the operations of method 800 may be performed by a display panel as described with reference to FIGS. 4 and 5. In some examples, a device may execute a set of codes to control the functional elements of the device to perform the functions described below. Additionally or alternatively, the device may perform aspects of the functions described below using special-purpose hardware.

At 805 the display panel may receive, from a host processor of the device, an inline pixel operation instruction for a display region of the display, wherein the inline pixel operation instruction comprises an indication of a first linear adjustment for a set of source pixel values. The operations of 805 may be performed according to the methods described herein. In certain examples, aspects of the operations of 805 may be performed by a inline operation manager as described with reference to FIGS. 4 and 5.

At 810 the display panel may read the set of source pixel values for the display region from a frame buffer of the display panel. The operations of 810 may be performed according to the methods described herein. In certain examples, aspects of the operations of 810 may be performed by a buffer manager as described with reference to FIGS. 4 and 5.

At 815 the display panel may generate a pixel pattern for the display region by applying the first linear adjustment to the set of source pixel values. The operations of 815 may be performed according to the methods described herein. In certain examples, aspects of the operations of 815 may be performed by a pixel pattern manager as described with reference to FIGS. 4 and 5.

At 820 the display panel may display the pixel pattern on the display. The operations of 820 may be performed according to the methods described herein. In certain examples, aspects of the operations of 820 may be performed by a output manager as described with reference to FIGS. 4 and 5.

At 825 the display panel may receive, from the host processor of the device, a second inline pixel operation instruction for the display region of the display, wherein the second inline pixel operation instruction comprises an indication of a second linear adjustment. The operations of 825 may be performed according to the methods described herein. In certain examples, aspects of the operations of 825 may be performed by a inline operation manager as described with reference to FIGS. 4 and 5.

At 830 the display panel may read the set of source pixel values for the display region from the frame buffer of the display panel. The operations of 830 may be performed according to the methods described herein. In certain examples, aspects of the operations of 830 may be performed by a buffer manager as described with reference to FIGS. 4 and 5.

At 835 the display panel may generate, based at least in part on the second inline pixel operation instruction, a second pixel pattern for the display region by applying the second linear adjustment to the set of source pixel values. The operations of 835 may be performed according to the methods described herein. In certain examples, aspects of the operations of 835 may be performed by a pixel pattern manager as described with reference to FIGS. 4 and 5.

At 840 the display panel may display the second pixel pattern on the display. The operations of 840 may be performed according to the methods described herein. In certain examples, aspects of the operations of 840 may be performed by a output manager as described with reference to FIGS. 4 and 5.

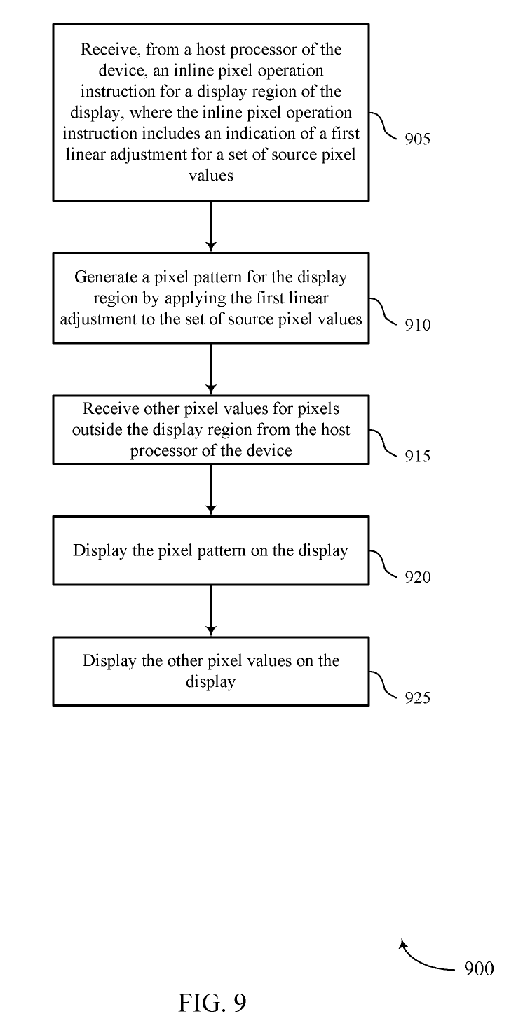

FIG. 9 shows a flowchart illustrating a method 900 for inline pixel operations for displays in accordance with aspects of the present disclosure. The operations of method 900 may be implemented by a device or its components as described herein. For example, the operations of method 900 may be performed by a display panel as described with reference to FIGS. 4 and 5. In some examples, a device may execute a set of codes to control the functional elements of the device to perform the functions described below. Additionally or alternatively, the device may perform aspects of the functions described below using special-purpose hardware.

At 905 the display panel may receive, from a host processor of the device, an inline pixel operation instruction for a display region of the display, wherein the inline pixel operation instruction comprises an indication of a first linear adjustment for a set of source pixel values. The operations of 905 may be performed according to the methods described herein. In certain examples, aspects of the operations of 905 may be performed by a inline operation manager as described with reference to FIGS. 4 and 5.

At 910 the display panel may generate a pixel pattern for the display region by applying the first linear adjustment to the set of source pixel values. The operations of 910 may be performed according to the methods described herein. In certain examples, aspects of the operations of 910 may be performed by a pixel pattern manager as described with reference to FIGS. 4 and 5.

At 915 the display panel may receive other pixel values for pixels outside the display region from the host processor of the device. The operations of 915 may be performed according to the methods described herein. In certain examples, aspects of the operations of 915 may be performed by a output manager as described with reference to FIGS. 4 and 5.

At 920 the display panel may display the pixel pattern on the display. The operations of 920 may be performed according to the methods described herein. In certain examples, aspects of the operations of 920 may be performed by a output manager as described with reference to FIGS. 4 and 5.

At 925 the display panel may display the other pixel values on the display. The operations of 925 may be performed according to the methods described herein. In certain examples, aspects of the operations of 925 may be performed by a output manager as described with reference to FIGS. 4 and 5. In some cases, the operations of 920 and 925 may be performed at the same time (e.g., for a same frame to be displayed via the display).

It should be noted that the methods described above describe possible implementations, and that the operations and the steps may be rearranged or otherwise modified and that other implementations are possible. Further, aspects from two or more of the methods may be combined. In some cases, one or more operations described above (e.g., with reference to FIGS. 6 through 9) may be omitted or adjusted without deviating from the scope of the present disclosure. Thus the methods described above are included for the sake of illustration and explanation and are not limiting of scope.

The various illustrative blocks and modules described in connection with the disclosure herein may be implemented or performed with a general-purpose processor, a DSP, an ASIC, a FPGA or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable median includes both non-transitory computer storage media and communication median including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, EEPROM, flash memory, CD-ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for refreshing a display at a display panel of a device, comprising:
receiving, from a host processor of the device, an inline pixel operation instruction for a display region of the display, wherein the inline pixel operation instruction comprises an indication of a first linear adjustment for a set of source pixel values;
generating a pixel pattern for the display region by applying the first linear adjustment to the set of source pixel values; and
displaying the pixel pattern on the display.

2. The method of claim 1, further comprising:
reading the set of source pixel values for the display region from a frame buffer of the display panel.

3. The method of claim 2, wherein applying the first linear adjustment to the set of source pixel values comprises:
applying a pixel multiplication factor to each pixel value of the set of source pixel values, wherein the indication of the first linear adjustment comprises the pixel multiplication factor.

4. The method of claim 2, further comprising:
receiving, from the host processor of the device, a second inline pixel operation instruction for the display region of the display, wherein the second inline pixel operation instruction comprises an indication of a second linear adjustment;
reading the set of source pixel values for the display region from the frame buffer of the display panel;
generating, based at least in part on the second inline pixel operation instruction, a second pixel pattern for the display region by applying the second linear adjustment to the set of source pixel values; and
displaying the second pixel pattern on the display.

5. The method of claim 4, wherein the first linear adjustment and the second linear adjustment comprise a same linear adjustment to the set of source pixel values such that the pixel pattern and the second pixel pattern comprise a same constant color block of pixels.

6. The method of claim 2, wherein the frame buffer of the display panel is unchanged between the first linear adjustment to the set of source pixel values and a subsequent linear adjustment to the set of source pixel values.

7. The method of claim 1, wherein generating the pixel pattern for the display region comprises:
determining a color component tuple for each pixel of the display region based at least in part on the indication of the first linear adjustment, wherein the pixel pattern for the display region is based at least in part on the color component tuple.

8. The method of claim 7, wherein applying the first linear adjustment to the set of source pixel values comprises:
applying a pixel multiplication factor to the color component tuple for each pixel of the display region, wherein the indication of the first linear adjustment comprises the pixel multiplication factor.

9. The method of claim 7, wherein applying the first linear adjustment to the set of source pixel values comprises:
creating an empty set of pixel values comprising the set of source pixel values; and
adjusting each pixel value of the empty set of pixel values based on the color component tuple.

10. The method of claim 1, further comprising:
receiving other pixel values for pixels outside the display region from the host processor of the device; and
displaying the other pixel values on the display.

11. The method of claim 1, wherein applying the first linear adjustment to the set of source pixel values comprises:
passing the set of source pixel values to an array of arithmetic logic units (ALUs); and
performing, by the array of ALUs and based at least in part on the inline pixel operation instruction, the first linear adjustment on the set of source pixel values.

12. An apparatus for refreshing a display, comprising:
means for receiving, from a host processor of the apparatus, an inline pixel operation instruction for a display region of the display, wherein the inline pixel operation instruction comprises an indication of a first linear adjustment for a set of source pixel values;
means for generating a pixel pattern for the display region by applying the first linear adjustment to the set of source pixel values; and
means for displaying the pixel pattern on the display.

13. The apparatus of claim 12, further comprising:
means for reading the set of source pixel values for the display region from a frame buffer of the apparatus.

14. The apparatus of claim 12, wherein the means for generating the pixel pattern for the display region comprises:
means for determining a color component tuple for each pixel of the display region based at least in part on the indication of the first linear adjustment, wherein the pixel pattern for the display region is based at least in part on the color component tuple.

15. The apparatus of claim 12, further comprising:
means for receiving other pixel values for pixels outside the display region from the host processor of the apparatus; and
means for displaying the other pixel values on the display.

16. An apparatus for refreshing a display, comprising:
a processor;
memory in electronic communication with the processor; and
instructions stored in the memory and executable by the processor to cause the apparatus to:
receive, from a host processor of the apparatus, an inline pixel operation instruction for a display region of the display, wherein the inline pixel operation instruction comprises an indication of a first linear adjustment for a set of source pixel values;
generate a pixel pattern for the display region by applying the first linear adjustment to the set of source pixel values; and
display the pixel pattern on the display.

17. The apparatus of claim 16, wherein the instructions are further executable by the processor to cause the apparatus to:
read the set of source pixel values for the display region from a frame buffer of the apparatus.

18. The apparatus of claim 17, wherein the instructions to apply the first linear adjustment to the set of source pixel values are executable by the processor to cause the apparatus to:
apply a pixel multiplication factor to each pixel value of the set of source pixel values, wherein the indication of the first linear adjustment comprises the pixel multiplication factor.

19. The apparatus of claim 16, wherein the instructions to generate the pixel pattern for the display region are executable by the processor to cause the apparatus to:
determine a color component tuple for each pixel of the display region based at least in part on the indication of the first linear adjustment, wherein the pixel pattern for the display region is based at least in part on the color component tuple.

20. The apparatus of claim 16, wherein the instructions are further executable by the processor to cause the apparatus to:
receive other pixel values for pixels outside the display region from the host processor of the apparatus; and
display the other pixel values on the display.
